(19) United States
(12) Patent Application Publication
(10) Pub. No.: US 2007/0081355 A1
(43) Pub. Date: Apr. 12, 2007

(54) Light generating unit, display device having the same, and method thereof

(76) Inventors: Sang Hoon Lee, Yongin-si (KR); Eun Jeong Kang, Asan-si (KR); Sang Yu Lee, Yongin-si (KR)

Correspondence Address: CANTOR COLBURN, LLP, 55 GRIFFIN ROAD SOUTH, BLOOMFIELD, CT, 06002, US

(21) Appl. No.: 11/502,025

(22) Filed: Aug. 10, 2006

(30) Foreign Application Priority Data
Oct. 11, 2005 (KR) 10-2005-0095702

(51) Int. Cl. B64D 47/06; F21V 5/00

(52) U.S. Cl. 362/559

(57) ABSTRACT

A light generating unit includes a plurality of light sources generating lights with different wavelengths. Among the light sources, at least one is disposed on a horizontal surface which differs in height from horizontal surfaces on which the other light sources are disposed. A display device includes the above light generating unit and a display panel for displaying an image by using the lights generated from the light generating unit. A method of improving color uniformity in the display device includes arranging the light sources as in the light generating unit.

This application claims priority to Korean Patent Application No. 2005-95702, filed on Oct. 11, 2005 and all the benefits accruing therefrom under 35 U.S.C. §119, and the contents of which in its entirety are herein incorporated by reference.

### BACKGROUND OF THE INVENTION

1. Field of the Invention

The present invention relates to a light generating unit, a display device having the same, and a method thereof. More particularly, the present invention relates to a light generating unit with excellent color uniformity, a display device having such a light generating unit, and a method of improving color uniformity in the display device.

2. Description of the Related Art

Generally, a liquid crystal display (“LCD”) device displays images by using electric and optical properties of liquid crystal disposed between electrodes of an LCD panel. The LCD device is small in volume and light in weight compared with a cathode ray tube (“CRT”), and as a result LCDs are widely used in notebook computers, telecommunication devices, liquid crystal televisions, etc.

In order to control the liquid crystal, the LCD device should be equipped with a liquid crystal control unit for controlling the liquid crystal and a light supplying unit for supplying light to the liquid crystal. For example, the LCD device may include the LCD panel as the liquid crystal control unit and a backlight assembly as the light supplying unit.

The backlight assembly includes a light source for generating light and a light guide plate for guiding the light and providing a plane light to the LCD panel. As the light source, a cold cathode fluorescent lamp (“CCFL”) in a cylinder shape or a light emitting diode (“LED”) in a dot shape are mainly used.

There are two kinds of LEDs: a white LED and an RGB LED. Compared to the CCFL, the white LED has no peak wavelength in green and red wavelength regions, resulting in a reduction of green and red color sense.

In order to solve such a problem, a spectrum of the white LED should be improved. However, it is not easy to change the spectrum in a short period with a current technique of producing a white light by coating a blue LED with a yellow fluorescent material. Therefore, instead of changing the spectrum of the white LED, it is preferable to use the RGB LED where one LED includes red, green, and blue chips.

A conventional RGB LED generates the white light by disposing the red, green, and blue chips on the same plane. However, luminance is not uniform and a color difference occurs because the amount of light emitted differs according to colors.

### BRIEF SUMMARY OF THE INVENTION

The present invention thus provides a light generating unit with excellent color uniformity.

The present invention also provides a display device having the above light generating unit.

The present invention also provides a method of improving color uniformity of the display device.

In accordance with exemplary embodiments of the present invention, there is provided a light generating unit including a plurality of light sources generating lights with different wavelengths. At least one of the light sources is disposed on a horizontal surface which differs in height from horizontal surfaces on which other light sources within the light generating unit are disposed.

The plurality of light sources includes red, green, and blue light emitting diodes.

The red light source generates light with a wavelength of 630 nm or more, the green light source generates light with a wavelength between 500 and 630 nm, and the blue light source generates light with a wavelength of 465 nm or less.

The red light source is disposed on a horizontal surface which is lower in height than a horizontal surface on which the green light source is disposed.

The blue light source is disposed on a horizontal surface which is higher in height than a horizontal surface on which the green light source is disposed.

The light sources are disposed at opposing ends of a panel or at a lower part of a panel.

The light generating unit may further include a substrate having a plurality of surfaces for supporting the plurality of light sources, respectively, wherein at least one of the surfaces is offset from remaining surfaces, such that the at least one of the surfaces is non-coplanar with respect to the remaining surfaces.

The substrate may include a groove for receiving one of the light sources, and the substrate may include a protrusion for supporting one of the light sources.

In accordance with other exemplary embodiments of the present invention, there is provided a display device having a light generating unit and a display panel. The light generating unit includes a plurality of light sources generating light with different wavelengths. The display panel displays an image by using the lights generated from the light generating unit. At least one of the light sources is disposed on a horizontal surface which differs in height from horizontal surfaces on which other light sources within the light generating unit are disposed.

The display device further includes a case for storing the plurality of light sources.

The display device further includes a light guide plate and/or a reflecting sheet.

In accordance with still other exemplary embodiments of the present invention, there is provided a display device with excellent color uniformity by adjusting heights of horizontal surfaces on which a plurality of light sources of a light generating unit are disposed. An optical path length between at least one of the light sources and the display panel is different from optical path lengths between other light sources within the light generating unit and the display panel.

In accordance with yet other exemplary embodiments of the present invention, there is provided a method of improving color uniformity in a display device including arranging a first light source, having a first wavelength, at a first optical path length from a display panel of the display device and arranging a second light source, having a second wavelength different from the first wavelength, at a second optical path length from the display panel, the second optical path length different from the first optical path length.

The first wavelength may be greater than the second wavelength, and the second optical path length may be less than the first optical path length.

The method may further include arranging a third light source, having a third wavelength between the first and second wavelengths, at a third optical path length from the display panel, the third optical path length between the first and second optical path lengths.

### BRIEF DESCRIPTION OF THE DRAWINGS

The above and other features and advantages of the present invention will become more apparent from the following detailed description when taken in conjunction with the accompanying drawings in which:

FIG. 1 is an exploded perspective view showing a first exemplary embodiment of a display device according to the present invention;

FIG. 2 is a partially enlarged view of part A shown in FIG. 1;

FIG. 3 is a cross-sectional view showing a first exemplary embodiment of a light generating unit according to the present invention;

FIG. 4 is a graph showing variations in luminance and color difference according to exemplary embodiments of the present invention; and

FIG. 5 is an exploded perspective view showing a second exemplary embodiment of another display device according to the present invention.

### DETAILED DESCRIPTION OF THE INVENTION

The invention will now be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

A preferred embodiment of the present invention will now be described herein below with reference to the attached drawings.

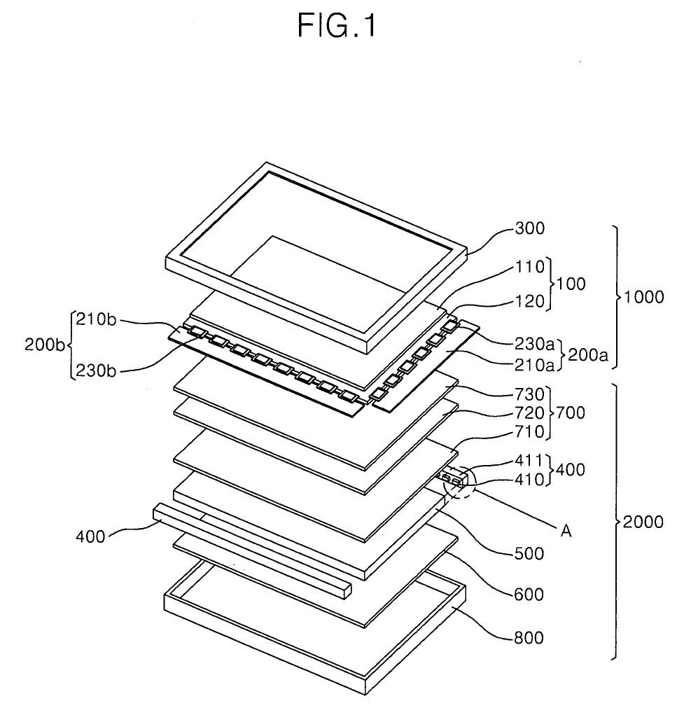

Referring to FIG. 1, a first exemplary embodiment of a display device according to the present invention includes a display assembly 1000 located in an upper part of the display device and a backlight assembly 2000 located in a lower part thereof.

The display assembly 1000 includes an LCD panel 100, a driving circuit 200a and 200b, and a front case 300.

The LCD panel 100 has a color filter substrate 110 and a thin film transistor (“TFT”) substrate 120. The color filter substrate 110 is a substrate on which color filters, i.e., RGB filters, for emitting predetermined colors when light passes therethrough are formed by a thin film process. A common electrode made of a transparent conductive material such as indium tin oxide (“ITO”) or indium zinc oxide (“IZO”) is coated on an entire surface, or at least substantially an entire surface, of the color filter substrate 110.

The TFT substrate 120 is a transparent glass substrate, or transparent plastic substrate, on which TFTs are formed in a matrix type. The TFT substrate 120 includes a plurality of gate lines extending in a first direction, and a plurality of data lines extending in a second direction, the first direction being substantially perpendicular to the second direction. The data lines may be insulated from the gate lines by a gate insulating layer. Each of the TFTs has a source terminal connected to a data line, a gate terminal connected to a gate line, and a drain terminal having a pixel electrode made of a transparent conductive material. Upon an input of an electric signal to the data and gate lines, each TFT is turned on or off to apply the electric signal necessary for the formation of a pixel of the drain terminal. If the TFT is turned on by supplying a power to the gate and source terminals of the TFT substrate 120, an electric field is formed between the pixel electrode and the common electrode of the color filter substrate 110, thus defining each color pixel of the LCD panel 100, and varies an arrangement of a liquid crystal injected between the TFT substrate 120 and the color filter substrate 110. Then light transmittance is varied and a desired image is obtained.

The driving circuit 200a, 200b connected to the LCD panel 100 is equipped with a control integrated circuit (“IC”). The driving circuit 200a, 200b includes a data printed circuit board (“PCB”) 210a for supplying a data signal to the data lines of the TFT substrate 120, a gate PCB 210b for applying a gate signal to the gate lines of the TFT substrate 120, a data flexible printed circuit board (“FPC”) 230a with an exposed ground pattern for connecting the TFT substrate 120 to the data PCB 210a, and a gate FPC 230b with an exposed ground pattern for connecting the TFT substrate 120 to the gate PCB 210b.

The data and gate PCBs 210a and 210b are connected to the data and gate FPCs 230a and 230b, respectively, in order to apply an external image signal and a gate driving signal, respectively. In an alternative embodiment, the data and gate PCBs 210a and 210b may be integrated into a single PCB and the integrated PCB may be connected to one side of the LCD panel 100. In such an embodiment, the data and gate lines of the TFT substrate 120 may be exposed to one side of the LCD panel 100.

The data and gate FPCs 230a and 230b are connected to the data and gate lines of the TFT substrate 120 in order to apply the data and gate driving signals to the TFTs, respectively. A tape automated bonding (“TAB”) IC is mounted on the FPCs 230a, 230b. For instance, the data FPC 230a supplies a data driving IC mounted thereon with an RGB signal, a shift start clock (“SSC”) signal, a latch pulse (“LP”) signal, a gamma analog ground signal, a digital ground signal, a digital power, and a gamma analog power which are generated from the data PCB 210a and also supplies the data lines of the TFT substrate 120 with an RGB signal that is converted into an analog signal from the data driving IC. Further, the data FPC 230a transmits to the TFT substrate 120 a common voltage and an accumulation voltage which are generated from the data PCB 210a. The gate FPC 230b supplies a gate driving IC mounted thereon with a digital power, a digital ground signal, and a TFT turn-on/turn-off voltage which are generated from the gate PCB 210b and also supplies the gate lines of the TFT substrate 120 with a gate driving signal generated from the gate driving IC. In this case, ICs may also be mounted on the TFT substrate 120.

The front case 300 may be shaped in a rectangular mold having a plane surface bent at right angles and sidewalls in order to prevent elements of the display assembly 1000 from deviating therefrom and to prevent the LCD panel 100 or the backlight assembly 2000 from being broken by an external shock. The front case 300 may cover the entire periphery of the backlight assembly 2000 including the LCD panel 100, or may cover a part of the backlight assembly 2000.

Meanwhile, the backlight assembly 2000 includes a light generating unit 400, a light guide plate 500 coupled to the light generating unit 400, a reflecting plate 600 disposed under the light guide plate 500, a plurality of optical sheets 700 disposed over the light guide plate 500, and a rear case 800 for storing the reflecting plate 600, the light guide plate 500, and the optical sheets 700. The rear case 800 may also store the light generating unit 400.

The light generating unit 400 has at least one LED group 410 and a thermal conductive substrate 411 on which a plurality of LED groups 410 may be assembled. As illustrated, the light generating unit 400 includes a plurality of LED groups 410. The thermal conductive substrate 411 emits heat generated from the LED group or groups 410 to the exterior of the light generating unit 400 and applies a predetermined voltage to the LED group or groups 410 mounted thereon. The efficiency of light can be maximized by forming a predetermined groove on the thermal conductive substrate 411, packaging the LED group 410 at the interior of the groove, and equipping the thermal conductive substrate 411 with a reflecting surface in a shape to encompass the LED group 410. At least one LED group 410 can be disposed on the thermal conductive substrate 411. Moreover, it is preferable to use a pair of light generating units 400 so that the light generating units 400 are disposed at a pair of inside sidewalls of the rear case 800 which face each other. In other words, the light generating units 400 are positioned at opposing sides of the backlight assembly 2000. While LED groups 410 are included in the light generating unit 400, a cold cathode florescent lamp (“CCFL”) may also be used within the light generating unit 400, or within one light generating unit 400 in a pair of opposing light generating units 400. A thermal pad (not shown) which is capable of conveying the heat of the thermal conductive substrate 411 to the sidewalls of the rear case 800 adjacent thereto may be formed between the thermal conductive substrate 411 and the rear case 800, thereby reducing a thermal resistance at a boundary.

The light guide plate 500 is disposed between the light generating units 400 and installed within the rear case 800, such that the light guide plate 500 is also positioned between the LCD panel 100 and a bottom panel of the rear case 800. If only one light generating unit 400 is employed, then the light guide plate 500, then one edge surface if the light guide plate 500 would be positioned to receive light from the light generating unit 400. The light guide plate 500 converts the light having an optical distribution of a line source generated from one or more light generating units 400 into the light having an optical distribution of a surface source. A wedge type plate or a parallel flat type plate may be used as the light guide plate 500. The light guide plate 500 may further include non-planar surface structures disposed or formed thereon for redirecting the light from the light generating units 400 in a direction towards the LCD panel 100 and for translating the line light into a planar light. Polymethylmethacrylate (“PMMA”) is preferably used as the light guide plate 500 because it is generally high in strength so that it is not easily strained or broken and it has good transmittance, although other materials with similar properties would also be within the scope of these embodiments. The light guide plate 500 may be disposed apart from the light generating unit 400 at given intervals or connected to the light generating unit 400. Alternatively, a part of the light generating unit 400 may be overlapped with the light guide plate 500.

The reflecting plate 600 uses a plate with high light reflexibility so as to reduce a light loss by re-reflecting the light emitted thereto through the rear surface of the light guide plate 500 in a direction back towards the light guide plate 500. The reflecting plate 600 is disposed such that it is in contact with the bottom surface of the rear case 800. Although the reflecting plate 600 is flat in shape in the drawing, it is possible to form the reflecting plate 600 in a curved shape having a reference reflective surface and a triangle-shape surface protruding from the reference reflective surface. Alternatively, if a material having enhanced reflecting efficiency is formed at the bottom surface of the rear case 800, the reflecting plate 600 may be omitted or the rear case 800 and the reflecting plate 600 may be integrally formed.

The plurality of optical sheets 700 includes a diffusion sheet 710, a luminance improving sheet 720, and a polarizing sheet 730 and these sheets are disposed on the light guide plate 500 to uniformize a luminance distribution of the light emitted from a light exiting surface of the light guide plate 500. The diffusion sheet 710 causes the light emitted from the light guide plate 500 to be directed to the front of the LCD panel 100 and to be irradiated to the LCD panel 100 by diffusing the light so as to have a uniform distribution throughout a wide range. A film made of a transparent resin on which a predetermined light diffusion member is coated at both surfaces is preferably used, although alternate diffusion sheets would also be within the scope of these embodiments. The luminance improving sheet 720 causes slant light among the incident light to the polarizing sheet 730 to be converted into vertical light. This is because light efficiency increases when the incident light to the LCD panel 100 is perpendicular thereto. Therefore, in order to convert the light emitted from the diffusion sheet 710 into the vertical light, at least one luminance improving sheet 720 may be disposed at a lower part of the LCD panel 100. In the preferred embodiment of the present invention, two luminance improving sheets 720 are used: a first luminance improving sheet for polarizing the light emitted from the diffusion sheet 710 in one direction and a second luminance improving sheet for polarizing the light in a perpendicular direction to the first luminance improving sheet. The polarizing sheet 730 transmits the light parallel to its transmission axis but reflects the light perpendicular to its transmission axis. It is preferable that the transmission axis of the polarizing sheet 730 has the same direction as the polarizing axis of the luminance improving sheet 720 in order to raise the transmittance efficiency. While particular embodiments of the optical sheets 700 have been described, it would be within the scope of these embodiments to include other sheets not described herein, or to eliminate certain sheets or all of the sheets described herein which may not be necessary for certain embodiments, such as, for example, forming less expensive LCD devices.

The rear case 800 is shaped with a box of a rectangular parallelepiped of which top surface is open and its interior has a storing space with a prescribed depth. The rear case 800 includes a bottom surface, and sidewalls protruded vertically from the bottom surface at its edges. The light generating units 400 are disposed at inner sides of two opposing sidewalls of the rear case 800 which face each other. In this case it is preferable that aluminum is used as the rear case 800 to protect the light generating unit 400 from an external shock and to give a cooling effect by uniformly distributing heat.

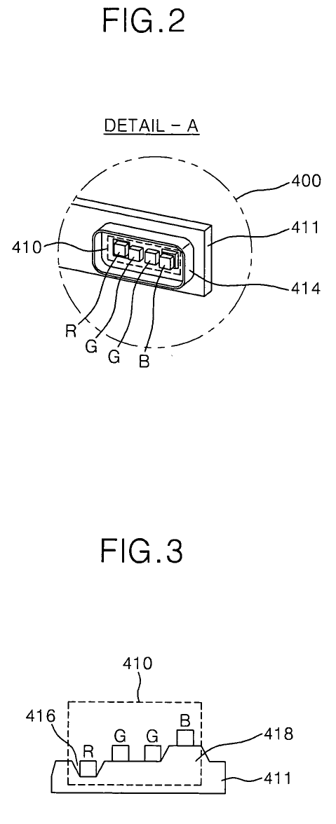

FIG. 2 is an enlarged view of part A of the light generating unit 400 of FIG. 1 in which one LED group 410 is mounted. FIG. 3 is a cross-sectional view of the LED group 410 shown in FIG. 2.

Each LED group 410 in the light generating unit 400 according to the present invention includes a plurality of light sources, such as first to third light sources, and at least one of theses light sources is located on a horizontal surface which differs in height from horizontal surfaces on which the other light sources are located. In other words, the light generating unit 400 arranges the light sources such that at least one of optical path lengths between the first to third light sources and the LCD panel 100 is different from other optical path lengths between other first to third light sources and the LCD panel 100. For example, the LED group 410 shown in FIGS. 2 and 3 includes R, G, and B LEDs and at least one of the horizontal surfaces on which theses LEDs are disposed differs in height with respect to other horizontal surfaces on which the remaining LEDs are mounted. The plurality of light sources generates different color lights and has different effective luminous areas so as to generate a white light by mixing those lights. If the R, G, and B LEDs are located on the horizontal surfaces of which heights are the same, a color distortion phenomenon worsens according to a side viewing angle. This is because the amount of red light increases but the amount of blue light decreases at the side of the panel and thus a phenomenon that a screen appears to be reddish occurs at the side of the panel. In order to reduce this color difference phenomenon, the amount of light can be adjusted by differently setting the heights of the horizontal surfaces on which the light sources are disposed. Although various methods may be used, it is preferable to lower the height of the horizontal surface on which the R LED is disposed when considering a phenomenon that the amount of red light increases at the side of the panel. Likewise, when considering a phenomenon that the amount of blue light decreases at the side of the panel, it is preferable to raise the height of the horizontal surface on which the B LED is disposed. Moreover, since each LED includes a semiconductor chip therein for emitting the light, the amount of light can be controlled by differently forming at least one of the heights of the horizontal surfaces on which the semiconductor chips are formed. In other words, it is preferable that the R, G, and B LEDs are disposed to lengthen a light path length between the R LED and the LCD panel and to shorten a light path between the B LED and the LCD panel. The arrangement of the light sources by the heights of the horizontal surfaces may be commonly applied to all of the LED groups 410 within the light generating unit 400 or partially applied in consideration of the characteristics of the LCD panel 100.

Each LED group 410 is mounted on the thermal conductive substrate 411 and located within a package 414 formed on the thermal conductive substrate 411. The package 414 is protruded from the thermal conductive substrate 411 and formed in a sidewall shape encompassing the LED group 410. The package 414 is equipped with a reflecting surface at its inner surface to improve light efficiency. The LED group 410 packaged within the package 414 includes the R and B LEDs disposed adjacent opposing ends of the package 414 with two G LEDs interposed therebetween. The R, G, and B LEDs generate a red light with a wavelength of 630 nm or more, a green light with a wavelength between 500 and 630 nm, and a blue light with a wavelength of 465 nm or less, respectively. Among the LEDs of the LED group 410, the heights of the horizontal surfaces on which the R and B LEDs are offset with respect to the height of the horizontal surface on which the G LEDs are disposed. That is, two G LEDs are mounted on the same horizontal surface of the thermal conductive substrate 411, and the R LED having the greater amount of light is mounted on a groove 416 formed on the thermal conductive substrate 411 and disposed on a lower horizontal surface with respect to the surface upon which the G LEDs are mounted. The B LED having the lesser amount of light is mounted on a protrusion 418 formed on the thermal conductive substrate 411 and disposed on a higher horizontal surface with respect to the surface upon which the G LEDs are mounted. By adjusting the amount of light exiting the LED group 410 by providing a difference in height of a horizontal surface on which each light source is disposed, color uniformity in the LCD panel 100 is improved.

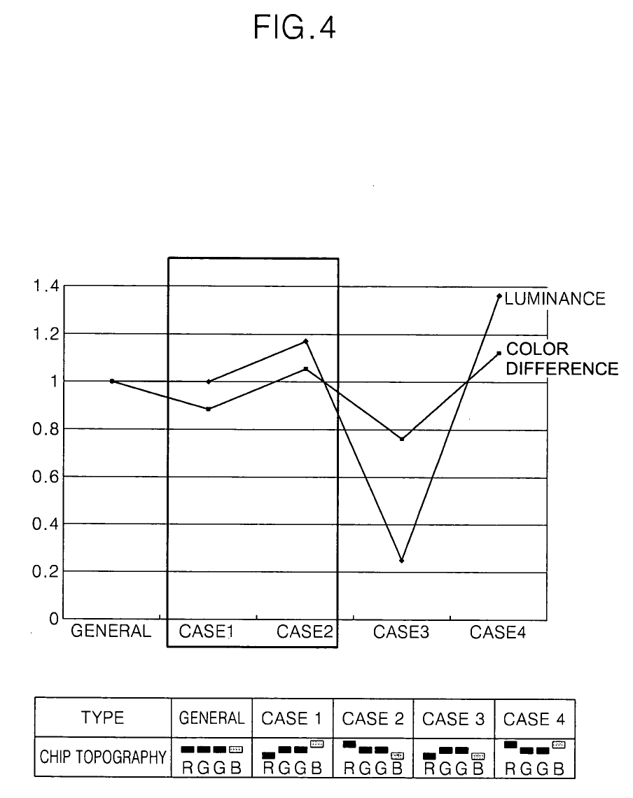

FIG. 4 is a graph illustrating a variation in luminance and color difference.

As shown in FIG. 4, color difference and luminance are graphed for exemplary chip topographies including a general case where the R, G, and B LEDs are substantially coplanar, and Cases 1, 2, 3, and 4 where the R, G, and B LEDs are variously positioned as will be further described. Case 1 is to lower the height of the horizontal surface on which the R LED is disposed and to raise the height of the horizontal surface on which the B LED is disposed; Case 2 is to raise the height of the horizontal surface on which the R LED is disposed and to lower the height of the horizontal surface on which the B LED is disposed; Case 3 is to lower the heights of the horizontal surfaces on which the R and B LEDs are disposed; and Case 4 is to raise the heights of the horizontal surfaces on which the R and B LEDs are disposed. As can be seen from the graph, color difference and luminance vary with each case. The characteristics of the display device can be enhanced by reducing the color difference and increasing the luminance. In Case 1, there is not a big difference in the luminance but the color difference is reduced; in Case 2, both the color difference and the luminance are increased; in Case 3, both the color difference and the luminance are reduced; and in Case 4, both the color difference and the luminance are increased. Although it is preferable to use a topography of an LED group 410 similar to that shown by Case 1, it is possible to select any of the 4 cases according to the characteristics of the light sources disposed at each part of the LCD panel or to dispose the light sources by other various methods if necessary.

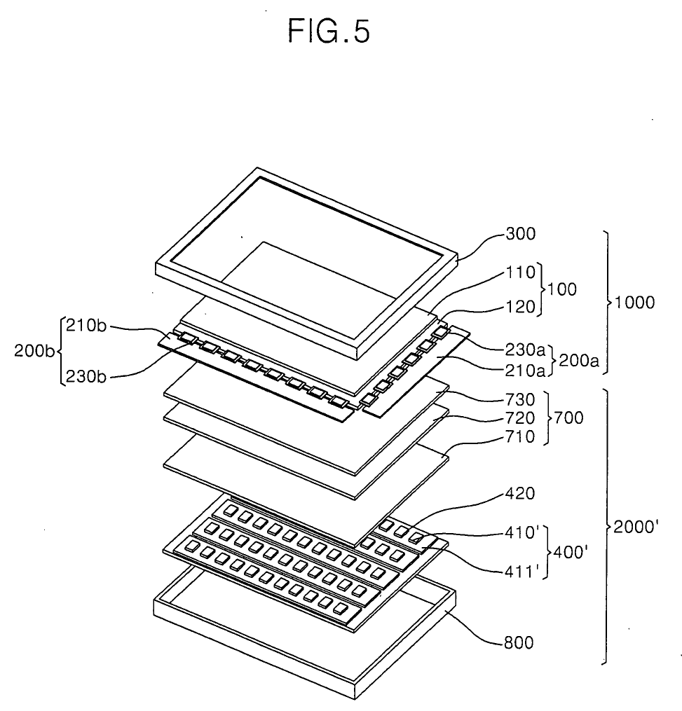

FIG. 5 is a perspective view showing a second exemplary embodiment of another display device according to the present invention.

The display device of FIG. 5 is similar to that of FIG. 1 but the arrangement of the light sources is different. In FIG. 1, there is shown an edge type backlight assembly where the light sources are formed at both ends, or at least one end, of the LCD panel. In FIG. 5, however, a direct type backlight assembly where the light sources are uniformly arranged at a bottom surface of the LCD panel is shown. The backlight assembly 2000′ includes the light generating unit 400′, the reflecting plate 420, the plurality of optical sheets 700, and the rear case 800 for storing the reflecting plate 420 and the optical sheets 700. The light generating unit 400′ may be further stored in the rear case 800. In this embodiment, since the light sources are directly located at the bottom surface of the LCD panel 100, it is unnecessary to provide an additional light guide plate for collecting the light toward the front of the panel 100, such as the light guide plate 500 used in the edge type backlight assembly shown in FIG. 1.

The light generating unit 400′ includes LED groups 410′, and a plurality of thermal conductive substrates 411′ on which the plurality of LED groups 410′ is mounted. Each of the thermal conductive substrates 411′ may include a bar shape, and the thermal conductive substrates 411′ are disposed in parallel in spaced rows beneath the LCD panel 100. The plurality of LED groups 410′ is disposed in a line at given intervals on each of the thermal conductive substrates 411′. That is, a column of LED groups 410′ is positioned on each thermal conductive substrate 411′, with a space disposed between each LED group 410′. Each of the LED groups 410′ includes the R, G, and B LEDs as aforementioned and at least one of the horizontal surfaces on which these LEDs are disposed differs in height from other horizontal surfaces within the LED group 410′. In other words, each of the LED groups 410′ includes the R, G, and B LEDs mounted on the thermal conductive substrate 411′ such that at least one of optical path lengths between the R, G, and B LEDs and the LCD panel 100 is different from the optical path lengths between at least one of the other LEDs and the LCD panel 100. The thermal conductive substrate 411′ emits heat generated from the LED groups 410′ to the exterior and applies a predetermined voltage to the LED groups 410′ mounted thereon. The reflecting plate 420 is additionally disposed under the thermal conductive substrate 411′ to reflect the light traveling to a lower part, and reflects the light back towards the LCD panel 100. The reflecting plate 420 may have a through-hole corresponding to each of the LED groups 410′ and it may be disposed on the thermal conductive substrate 411′ on which the LED groups 410′ are mounted.

As described previously, the present invention provides the light generating unit having enhanced color uniformity by differently forming one of the heights of the horizontal surfaces on which a plurality of light sources is disposed, or by otherwise altering an optical path length or physical distance between a light source and a display panel to be different from an optical path length or physical distance between another light source and the display panel. Furthermore, the present invention provides the display device including the light generating unit having enhanced color uniformity and a method of improving color uniformity in a display device by arranging the light sources having different wavelengths at different optical path lengths from the display panel of the display device.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A light generating unit comprising:
a plurality of light sources generating lights with different wavelengths;
wherein at least one of the light sources is disposed on a horizontal surface which differs in height from horizontal surfaces on which other light sources within the light generating unit are disposed.

2. The light generating unit as claimed in claim 1, wherein the plurality of light sources include light emitting diodes.

3. The light generating unit as claimed in claim 2, wherein the plurality of light sources are red, green, and blue light sources.

4. The light generating unit as claimed in claim 3, wherein the red light source generates light with a wavelength of 630 nm or more, the green light source generates light with a wavelength between 500 and 630 nm, and the blue light source generates light with a wavelength of 465 nm or less.

5. The light generating unit as claimed in claim 4, wherein the red light source is disposed on a horizontal surface which is lower in height than a horizontal surface on which the green light source is disposed.

6. The light generating unit as claimed in claim 5, wherein the blue light source is disposed on a horizontal surface which is higher in height than a horizontal surface on which the green light source is disposed.

7. The light generating unit as claimed in claim 6, wherein the plurality of light sources are disposed at opposing ends of a panel.

8. The light generating unit as claimed in claim 6, wherein the plurality of light sources are disposed at a lower part of a panel.

9. The light generating unit as claimed in claim 1, further comprising a substrate having a plurality of surfaces for supporting the plurality of light sources, respectively, wherein at least one of the surfaces is offset from remaining surfaces.

10. The light generating unit as claimed in claim 9, wherein the at least one of the surfaces is non-coplanar with respect to the remaining surfaces.

11. The light generating unit as claimed in claim 9, wherein the substrate includes a groove for receiving one of the light sources.

12. The light generating unit as claimed in claim 9, wherein the substrate includes a protrusion for supporting one of the light sources.

13. A display device comprising:
a light generating unit including a plurality of light sources for generating light with different wavelengths; and
a display panel for displaying an image by using light generated from the light generating unit;
wherein at least one of the light sources is disposed on a horizontal surface which differs in height from horizontal surfaces on which other light sources within the light generating unit are disposed.

14. The display device as claimed in claim 13, wherein the plurality of light sources include light emitting diodes.

15. The display device as claimed in claim 14, wherein the plurality of light sources are red, green, and blue light sources.

16. The display device as claimed in claim 15, wherein the red light source generates light with a wavelength of 630 nm or more, the green light source generates light with a wavelength between 500 and 630 nm, and the blue light source generates light with a wavelength of 465 nm or less.

17. The display device as claimed in claim 16, wherein the red light source is disposed on a horizontal surface which is lower in height than a horizontal surface on which the green light source is disposed.

18. The display device as claimed in claim 17, wherein the blue light source is disposed on a horizontal surface which is higher in height than a horizontal surface on which the green light source is disposed.

19. The display device as claimed in claim 18, wherein the plurality of light sources are disposed at opposing ends of the display panel.

20. The display device as claimed in claim 19, further comprising a case for storing the plurality of light sources.

21. The display device as claimed in claim 20, further comprising a reflecting sheet stored in the case.

22. The display device as claimed in claim 18, wherein the plurality of light sources are disposed at a lower part of the display panel.

23. The display device as claimed in claim 18, further comprising a case for storing the plurality of light sources.

24. The display device as claimed in claim 23, further comprising a light guide plate and a reflecting sheet which are stored in the case.

25. A display device, comprising:
a light generating unit including a plurality of light sources for generating lights with different wavelengths; and
a display panel for displaying an image by using the lights generated from the light generating unit;
wherein an optical path length between at least one of the light sources and the display panel is different from optical path lengths between other light sources within the light generating unit and the display panel.

26. The display device as claimed in claim 25, further comprising a substrate on which the light sources are mounted, wherein at least one of the light sources is disposed on a horizontal surface which differs in height from horizontal surfaces on which the other light sources are disposed.

27. The display device as claimed in claim 25, wherein the plurality of light sources include light emitting diodes having semiconductor chips for emitting light from an interior of each of the light emitting diodes, and at least one of the semiconductor chips is formed on a horizontal surface which differs in height from horizontal surfaces on which semiconductor chips of other light emitting diodes within the plurality of light sources are disposed.

28. A method of improving color uniformity in a display device, the method comprising:
arranging a first light source, having a first wavelength, at a first optical path length from a display panel of the display device; and,
arranging a second light source, having a second wavelength different from the first wavelength, at a second optical path length from the display panel, the second optical path length different from the first optical path length.

29. The method of claim 28, wherein the first wavelength is greater than the second wavelength, and the second optical path length is less than the first optical path length.

30. The method of claim 28, further comprising arranging a third light source, having a third wavelength between the first and second wavelengths, at a third optical path length from the display panel, the third optical path length between the first and second optical path lengths.
